(19) United States
(12) Patent Application Publication
(10) Pub. No.: US 2017/0204930 A1
(43) Pub. Date: Jul. 20, 2017

(54) PISTON AND SHOCK ABSORBER

(71) Applicant: KYB CORPORATION, Tokyo (JP)

(72) Inventors: Masahiro MIWA, Tokyo (JP); Yusuke MATSUSHITA, Tokyo (JP)

(73) Assignee: KYB CORPORATION, Tokyo (JP)

(21) Appl. No.: 15/326,182

(22) PCT Filed: Sep. 26, 2014
(86) PCT No.: PCT/JP2014/075585

§ 371 Date: Jan. 13, 2017

(30) Foreign Application Priority Data
Jul. 23, 2014 (JP) 2014-149354

(51) Int. Cl. F16F 9/32; F16F 9/348; F16F 9/19

(52) U.S. Cl. CPC F16F 9/3214; F16F 9/19; F16F 9/348; F16F 2232/08; F16F 2226/04; B60G 2202/24; F16F 9/065

(57) ABSTRACT

A piston includes: a disk-shaped piston body; an annular valve seat axially projecting from a first end of the piston body; and at least one port axially extending from the area inside the annular valve seat in the first end of the piston body to a second end of the piston body, and the port has a cross-sectional shape of a rounded rectangular having two arc-shaped opposite sides on one circle, the cross-sectional shape being the same all the way along the piston body.

### TECHNICAL FIELD

The present invention relates to a piston and a shock absorber.

### BACKGROUND ART

A piston slidably disposed in a cylinder of a shock absorber separates the inside of the cylinder into two pressure chambers and includes an extension-side port through which hydraulic oil passes during the extension of the shock absorber and a compression-side port through which hydraulic oil passes during the compression of the shock absorber, for example. The piston of this type has a leaf valve disposed on each of the top and bottom ends. These leaf valves open or close the exits of the extension-side and compression-side ports. The leaf valve generates damping force by giving resistance to the flow of the hydraulic oil passing through the extension-side port or the compression-side port when the shock absorber is extended or compressed.

In recent years, it has been required that the shock absorber, which is incorporated in a suspension system between a body and a wheel of a vehicle, achieves a rapid rise in damping force at a low speed of the piston and decreases the rate of rise in damping force in relation to the piston speed at a high speed of the piston especially on the extension-side damping force properties for improving the riding comfort of the vehicle.

The shock absorber having the above damping force properties can restrict the vibration of the vehicle at a low speed of the piston while restricting an excessive rise in damping force at a high speed of the piston, resulting in the improvement in the riding comfort of the vehicle.

To achieve the above damping force properties, it is required to increase the pressure receiving area of the leaf valve as much as possible, to increase the diameter the valve seat for receiving the leaf valve, and to increase the cross-sectional area of the port.

The leaf valve having a larger pressure receiving area can efficiently be operated by a smaller pressure. The valve seat having a larger diameter can receive a leaf valve having a greater length corresponding to the length from an inner circumferential supporting portion to the valve seat and a lower flexural rigidity. The port having a larger cross-sectional area can reduce the resistance in the hydraulic oil passing through the port. The shock absorber haying these features is disclosed in JP 2013-190044 A. In the shock absorber, the leaf valve bends more easily and makes a larger gap with the valve seat when the leaf valve comes off the valve seat. In addition, the shock absorber has a small-resistance port that gives a smaller resistance to the flow of hydraulic oil at a high speed of the piston. The shock absorber thereby achieves the above damping force properties.

### SUMMARY OF THE INVENTION

As described above, the port should preferably have a larger cross-sectional area. If the port, which needs to be formed between the valve seat for receiving the leaf valve and the inner circumferential seat portion to which the leaf valve is fixed, is round, there is a limitation in increasing the cross-sectional area of the port.

The cross-sectional area of the port can be increased by adopting a port having an arc-shaped cross section. An arc-shaped port can be formed in the piston by making an arc-shaped hole in the piston, however, the process takes a long time and increases the manufacturing costs. Since the piston is generally made by sintering, the port is formed in the piston by molding.

Specifically, the piston is made by inserting a core for forming the port into a sintering mold. To form the port having an arc-shaped cross section, the core for forming the port should also have the arc-shaped cross section. The mold with such a core is expensive.

An object of the present invention is to reduce the manufacturing costs for the piston and the shock absorber.

According to an aspect of the present invention, there is provided a piston including: a disk-shaped piston body; an annular valve seat axially projecting from a first end of the piston body; and at least one port axially extending from the area inside the annular valve seat in the first end of the piston body to a second end of the piston body, wherein the pore has a cross-sectional shape of a rounded rectangular having two arc-shaped opposite sides on one circle, the cross-sectional shape being the same all the way along the piston body.

According to another aspect of the present invention, there is provided a shock absorber including: a cylinder; and a piston slidably disposed in the cylinder and separating the inside of the cylinder into an extension-side chamber and a compression-side chamber, the piston including: a disk-shaped piston body; an annular valve seat axially projecting from a first end of the piston body, and at least one port axially extending from the area inside the annular valve seat in the first end of the piston body to a second end of the piston body, wherein the port has a cross-sectional shape of a rounded rectangular having two arc-shaped opposite sides on one circle, the cross-sectional shape being the same all the way along the piston body.

### BRIEF DESCRIPTION OF DRAWINGS

FIG. 1 is a vertical cross-sectional view of a shock absorber according to an embodiment of the present invention.

FIG. 2 is an enlarged vertical cross-sectional view of a piston of the shock absorber according to the embodiment of the present invention.

FIG. 3 is a bottom view of a piston body.

FIG. 4 is a plane view of the piston body.

FIG. 5 is a cross-sectional view of a mold for the piston.

FIG. 6A illustrates the mold be fore being filled with metal powder material.

FIG. 6B illustrates the mold filled with metal powder material.

FIG. 6C illustrates the mold compressing the metal powder

### DESCRIPTION OF EMBODIMENTS

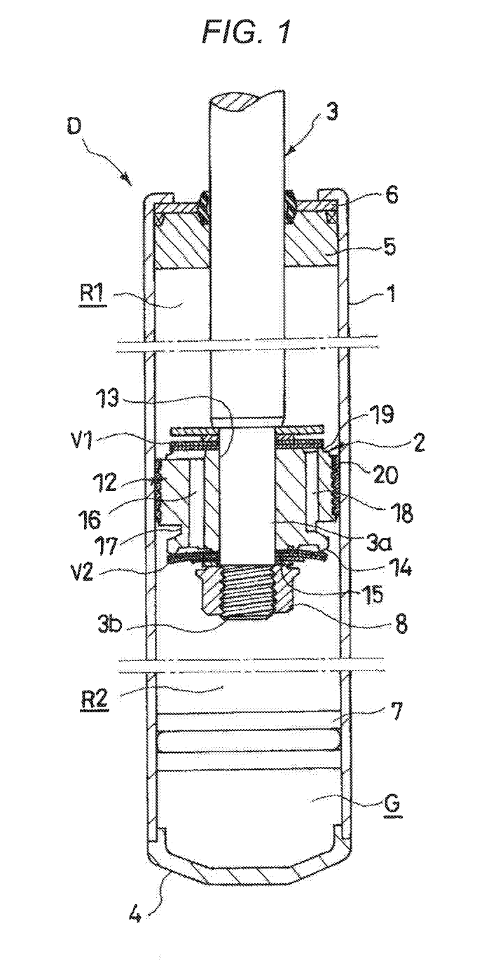

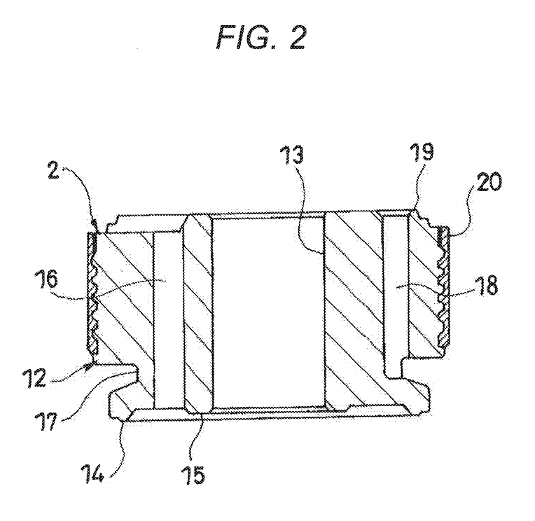

A shock absorber according to an embodiment of the present invention will be described below with reference to the drawings In the following description, the upper side of FIGS. 1, 2, and 5 is referred to as the upper side (such as upward, upper end, upper surface) and the lower side of FIGS. 1, 2, and 5 is referred to as the lower side (such as downward, lower end).

As illustrated in FIG. 1, the shock absorber D includes a cylinder 1, a piston 2 slidably disposed in the cylinder 1 and separating the inside of the cylinder 1 into an extension-side chamber R1 and a compression-side chamber R2, a piston rod 3 having one end coupled to the piston 2 and the other end projecting outside the cylinder 1, and a slidable partition wall slidably disposed on the inner surface of the cylinder 1 and separating a gas chamber G from the compression-side chamber R2.

The extension side chamber R1 and the compression-side chamber R2 are filled with such as hydraulic oil. The extension-side chamber R1 and the compression-side chamber R2 may be filled with liquid such as water and solution other than hydraulic oil. The gas chamber G is filled with inert gas such as nitrogen. The gas chamber G may be filled with gas other than inert gas.

The lower end of the cylinder 1 is closed by a bottom cap 4. An annular rod guide 5 is disposed at the upper end of the cylinder 1 for slidably supporting the piston rod 3. A sealing member 6 is slidably disposed around the outer surface of the piston rod 3 between the upper end of the cylinder 1 and the upper surface of the rod guide 5. The sealing member 6 seals the gap around the cuter surface of the piston rod 3 to prevent the leakage of liquid from the cylinder 1.

As illustrated in FIGS. 1 to 3, the piston 2 includes a disk-shaped piston body 12 having a central bore 13 for accepting the piston rod 3, an annular valve seat 14 axially projecting from a first end or the lower end of the piston body 12, an annular inner circumferential seat portion 15 axially projecting from the area inside the annular valve seat 14 in the first end of the piston body 12, a plurality of extension-side ports 16 that are located between the annular valve seat 14 and the inner circumferential seat portion 15 on the first end of the piston body 12 and axially extend from there to a second end or the upper end of the piston body 12, an annular groove 17 in the outer surface of the piston body 12, and compression-side ports 18 that is open at the second end of the piston body 12 and in communication with the annular groove 17, and a petal-like valve seat 19 that is formed on the second end of the piston body 12 and surrounds only the compression-side ports 18 while excluding the extension-side ports 16. A cylindrical piston ring 20 of synthetic resin is disposed around the outer surface of the piston body 12.

The piston body 12 has a smaller diameter at the first end below the annular groove 17 than at the second end.

The annular valve seat 14 projects downward from the area near the outer circumferential edge in the lower end of the piston body 12. The inner circumferential seat portion 15 is annular, and projects downward from the first end of the piston body 12 and surrounds the opening of the bore 13.

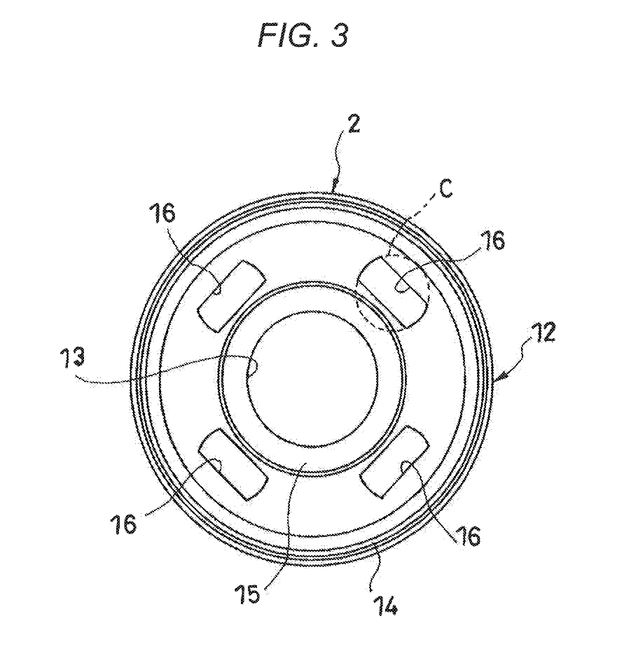

As illustrated in FIG. 3, the extension-side port 16 has a cross-sectional shape of a rounded rectangular having rounded short sides in a cross section perpendicular to the axial direction. Specifically, the two opposite sides of the rounded rectangular are the arcs of a virtual circle C indicated by the dashed line in FIG. 3. The extension-side port 16 has thus a cross-sectional shape of the virtual circle cut by parallel lines. The extension-side port 16 has the same cross-sectional shape all the way from the first end to the second end of the piston body 12. The extension-side port 16 is open between the annular valve seat 14 and the inner circumferential seat portion 15 at the first end or the lower end of the piston body 12 and axially extends from there to the second end or the upper end of the piston body 12. As illustrated in FIG. 3, four extension-side ports 16 are evenly disposed in the circumferential direction. The number of the extension-side ports 16 is not limited to four and may be one or more other than 4.

The compression-side port 18 is open at the second end or the upper end of the piston body 12 and in communication with the annular groove 17. Since the piston body 12 has a smaller diameter below the annular groove 17, the annular groove 17 is not closed by the cylinder 1 when the piston 2 is inserted in the cylinder 1. The compression-side port 18 thereby ensures the communication between the extension-side chamber R1 and the compression-side chamber R2.

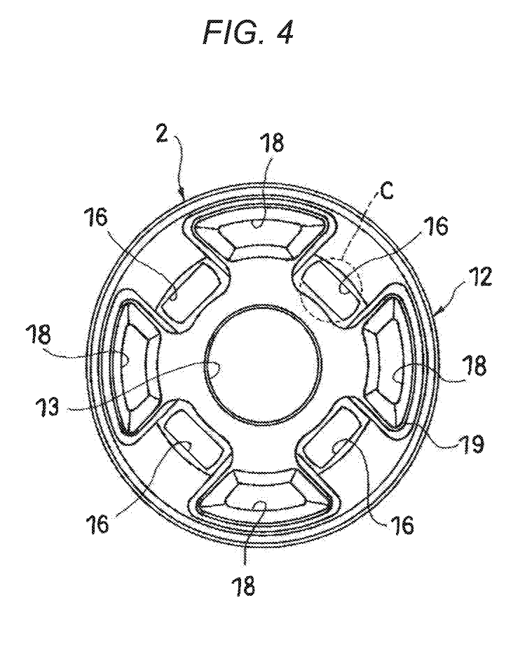

As illustrated in FIG. 4, the petal-like valve seat 19 projects upward from het second end or the upper end of the piston body 12. The valve seat 19 surrounds the opening of the compression-side port 18 in the second end of the piston body 12. The valve seat 19 excludes the opening of the extension-side port 16 in the second end of the piston body 12. As illustrated in FIG. 4, four compression-side ports 18 are evenly disposed the circumferential direction. The number of the compression-side ports 18 is not limited to four and may be one or more other than four.

An annular compression-side leaf valve V1 is disposed on the valve seat 19 on the second end or the upper end of the piston 2 facing the extension-side chamber R1. An annular extension-side leaf valve V2 is disposed on the annular valve seat 14 on the first end or the lower end of the piston 2 facing the compression-side chamber R2.

The compression-side leaf valve V1 and the extension-side leaf valve V2 are disposed around a small-diameter piston attachment portion 3a at the tip end of the piston rod 3 while being disposed on the piston 2. Specifically, after the piston 2 having the compression-side leaf valve V1 and the extension-side leaf valve V2 disposed thereon is disposed around the piston attachment portion 3a, a piston nut 8 is screwed on a screw portion 3b at the tip end of the piston attachment portion 3a. The piston 2, the compression-side leaf valve V1, and the extension-side leaf valve V2 are thereby fixed around the piston rod 3.

When the piston 2, the compression-side leaf valve V1, and the extension-side leaf valve V2 are fixed around the piston rod 3 in this manner, the compression-side leaf valve V1, and the extension-side leaf valve V2 can bend at the outer circumferential edges while being fixed to the piston rod 3 at the inner circumferential edges.

The compression-side leaf valve 1 closes the compression-side port 18 when being in contact with the valve seat 19 and opens the compression-side port 18 when bending upwards at the outer circumferential edge. Since the valve seat 19 surrounds only the compression-side port 18 while excluding the extension-side port 16, the compression-side leaf valve V1 does not close the extension-side port 16 when being in contact with the valve seat 19. The extension-side leaf valve V2 closed the extension-side port 16 when being in contact with the annular valve seat 14 and opens the extension-side port 16 when bending downward at the outer circumferential edge. The compression-side port 18 is always in communication with the annular groove 17 and the compression-side chamber R2. The gap between the outer surface of the piston body 12 and the cylinder 1 below the annular groove 17 ensures the communication between the annular groove 17 and the compression-side chamber R2, allowing liquid to travel from the compression-side chamber R2 to the extension-side chamber R1 through the compression-side port 18 during a compression stroke of the shock absorber D. Accordingly, the annular valve seat 14 surrounding the extension-side port 16 can be annular and have a larger diameter close to the inside diameter of the cylinder 1. As a result, the extension-side leaf valve V2 can have a larger pressure receiving area.

The operation of the shock absorber D will now be described.

When the piston 2 moves downward in the cylinder 1 and the shock absorber P is compressed, tie extension-side leaf valve V2 is pressed toward the piston 2 by the pressure increased in the compression-side chamber R2 due to the compression and closes the extension-side port 16. On the other hand, the compression-side leaf valve V1 is subjected to the pressure from the compression-side chamber R2 applied through the compression-side port 18 to bend and come off the valve seat 19 and opens the compression-side port 18. Since the compression-side leaf valve V1 gives resistance to the flow of the liquid traveling from the compression-side chamber R2 to the extension-side chamber R1 through the compression-side port 18 at this time, the shock absorber P generates a compression-side damping force for damping the compression.

When the piston 2 moves upward in the cylinder 1 and the shock absorber P is extended, the compression-side leaf valve V1 is pressed toward the piston 2 by the pressure increased in the extension-side chamber R1 due to the compression and closes the compression-side port 18. On the other hand, the extension-side leaf valve V2 is subjected to the pressure from. the extension-side chamber R1 applied through the extension-side port 16 to bend and come off the annular valve seat 14 and opens the extension-side port 16. Since the extension-side leaf valve V2 gives resistance to the flow of the liquid traveling from the extension-side chamber R1 to the compression-side chamber R2 through the extension-side port 16 at this time, the shock absorber D generates an extension-side damping force for damping the extension.

As described above, the annular valve seat 14 surrounding the extension-side port 16 can be annular and have a larger diameter close to the inside diameter of the cylinder 1. Accordingly, the extension-side leaf valve V2 can have a larger pressure receiving area for receiving the pressure from the extension-side chamber R1 and a larger diameter of the portion to come in contact with the annular valve seat 14.

Since the extension-side leaf valve V2 can have such a larger pressure receiving area, the extension-side leaf valve V2 can substantially be bent by a small pressure. Since the extension-side leaf valve 2 can have such a larger diameter of the portion to come in contact with the annular valve seat 14, the extension-side leaf valve V2 can have a lower flexural rigidity. Since the extension-side port 16 has a cross-sectional shape of a rounded rectangular, the extension-side port 16 can easily be disposed between the annular valve seat 14 and the inner circumferential seat portion 15 while having a larger cross-sectional area. Accordingly, the extension-side leaf valve V2 can substantially be bent by a small pressure. When the piston speed gets high in an extension stroke of the shock absorber D, the extension-side leaf valve V2 is substantially bent to open the extension-side port 16 having a larger cross-sectional area. The shock absorber D of the present embodiment achieves a rapid rise in damping force at a low speed of the piston and decreases the rate of rise in damping force in relation to the piston speed at a high speed of the piston in an extension stroke of the shock absorber D. The volume of the piston rod 3 coming in and out of the cylinder 1 is absorbed by the slidable partition wall 7 moving in the cylinder 1 to contract or expand the gas chamber G. The shock absorber D is a mono-tube shock absorber, however, the shock absorber D may be a twin-tube shock absorber having a base valve at the lower end of the cylinder 1 and a reservoir outside the cylinder.

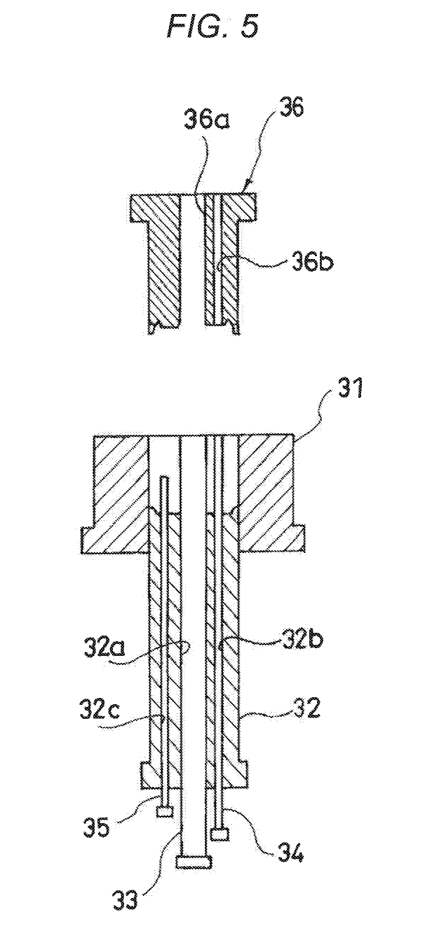

The processes of manufacturing the piston 2 will now be described. The piston 2 is made by sintering. As illustrated in FIG. 5, the mold for the piston 2 includes a cylindrical die 31 that is an outer mold for accommodating metal powder, a lower punch 32 as a lower mold that can be slidably inserted in the die 31, a cylindrical center core 33 to axially and slidably penetrate the lower punch 32 at the center for forming the bore 13 for accepting the piston rod 3 in the piston 2, a first side core 34 to axially and slidably penetrate the lower punch 32 for forming the extension-side port 16 in the piston 2, a second side core 35 to axially and slidably penetrate the lower punch 32 for forming the compression-side port 18 in the piston 2, and an upper punch 36 as an upper mold that can be slidably inserted in the die 31. The upper punch 36 has bores 36a and 36b for accepting the center core 33 and the first side core 34, respectively.

The lower punch 32 can slidably be inserted in the die 31 to move in the die 31. The lower punch 32a has a bore 32 at the center for accepting the center core 33, and bores 32b and 32c respectively at the position of the extension-side port 16 and at the position of the compression-side port 18 for accepting the first side core 34 and the second side core 35. The lower punch 32 has an uneven area in the upper end for forming the valve seat 19 of the piston 2.

The upper punch 36 can slidably be inserted in the die 31 to move d the die 31. The upper punch 36 has a bore 36aat the center for accepting the center core 33, and a bore 36b at the position of the extension-side port 16 for accepting the first side core 34. The upper punch 36 has an uneven area in the lower end for forming the annular valve seat 14 and the inner circumferential seat portion 15 in the piston 2.

The center core 33 is a cylindrical member and can slidably be inserted in the bore 32a in the lower punch 32 and the bore 36a in the upper punch 36. The first side core 34 can slidably be inserted in the bore 32b in the lower punch 32 and the bore 36b in the upper punch 36. The first side core 34 has the same cross-sectional shape of a rounded rectangular having two arc-shaped opposite sides as the cross-sectional shape of the extension-side port 16 illustrated in FIG. 3. The first side core 34 is made by cutting a round bar such that the core has two parallel sides along the axis of the core. The first side core 34 can thereby easily be made at low costs.

The second side core 35 can slidably be inserted in the bore 32c in the lower punch 32. The second side core 35 has the same cross-sectional shape of an arc as the cross-sectional shape of the compression-side port 18 illustrated in FIG. 4. The second side core 35 may have a cross-sectional shape of a rounded rectangular having two arc-shoed opposite sides like the first side core 34. In this case, the second side core 35 can also easily be made at low costs.

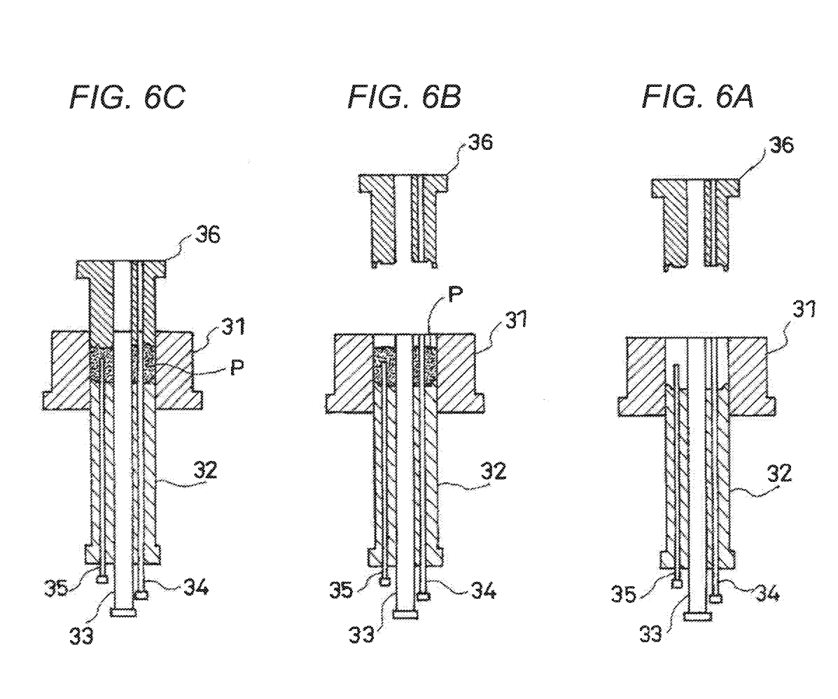

The piston 2 is made with the above mold as follows. As illustrated in FIG. 6A, the lower punch 32 is inserted in the die 31, and then the center core 33, the first side core 34, and the second side core 35 are inserted in the lower punch 32 to be disposed in the die 31. Since the compression-side port 18 does not reach the second end of the piston 2, the second side core 35 for forming the compression-side port 18 is disposed such that its upper end does not reach the upper punch 36.

As illustrated in FIG. 6B, metal powder material P is poured into the die 31 while the state illustrated in FIG. 6A is maintained. As illustrated in FIG. 6C, the upper punch 36 is inserted in the die 31 from the top to compress the metal powder material P while heating the metal powder material P. The metal powder material P is compressed between the lower punch 32 and the upper punch 36 in the die 31 to be molded. The piston 2 is thereby formed. The above configuration of the mold is merely an example and can be modified in accordance with the shape of the piston 2. After sintering, the piston 2 is took out from the mold and subjected to processing such as cutting to have the annular groove 17. The piston 2 is thereby completed.

The extension side port 16 has a cross-sectional shape of a rounded rectangular having two arc-shaped opposite sides on one circle. The mold for forming the extension-side port 16 which is used in sintering of the piston 2, can thereby easily be made at low costs. Since the mold can be made at low costs, the manufacturing costs for the piston 2 and the shock absorber cart be reduced.

In the present embodiment, only the extension-side port 16 has a cross-sectional shape of a rounded rectangular, however, the compression-side port 18 may have the same or a similar cross-sectional shape of a rounded rectangular as or to the cross-sectional shape of the extension-side port 16. In this case, since the mold for the piston 2 can be made at further lower costs, the manufacturing costs for the piston 2 and the shock absorber D can further be reduced.

The advantageous effects of the present invention can be achieved as long as at least one of the ports has the cross-sectional shape of the above rounded rectangular. The piston 2 may have any shape other than the shape described in the above embodiment.

The embodiment of the present invention has been described above, however, the above embodiment is merely an example of applications of the invention and the scope of the invention shall not be limited to the specific configurations of the above embodiment.

The present application claims a priority based on Japanese Patent application No. 2014-149354 filed to the Japan Patent Office on Jul. 23, 2014 and the entire contents of the priority application are incorporated herein by reference.

1. A piston comprising:
a disk-shaped piston body;
an annular valve seat axially projecting from a first end of the piston body; and
at least one port axially extending from the area inside the annular valve seat in the first end of the piston body to a second end of the piston body,
wherein the port has a cross-sectional shape of a rounded rectangular having two parallel sides and two arcs on one circle connecting the ends of the parallel sides, the cross-sectional shape being the same all the way from the first end to the second end of the piston body.

2. A shock absorber comprising:
a cylinder; and
a piston slidably disposed in the cylinder and separating the inside of the cylinder into an extension-side chamber and a compression-side chamber,
the piston including:
a disk-shaped piston body;
an annular valve seat axially projecting from a first end of the piston body; and
at least one port axially extending from the area inside the annular valve seat in the first end of the piston body to a second end of the piston body,
wherein the port has a cross-sectional shape of a rounded rectangular having two parallel sides and two arcs on one circle connecting the ends of the parallel sides, the cross-sectional shape being the same all the way from the first end to the second end of the piston body.

3. The shock absorber according to claim 2,
wherein the piston body is made by sintering, and
the port is formed with a mold made by cutting a round bar such that the mold has two parallel sides along the axis of the mold.
